(19) United States
(12) Patent Application Publication
(10) Pub. No.: US 2025/0321150 A1
(43) Pub. Date: Oct. 16, 2025

(54) CHASSIS DYNAMOMETER APPARATUS

(71) Applicant: TOYO ELECTRIC MFG. CO., LTD., Tokyo (JP)

(72) Inventor: Yuuta Funaki, Shiga (JP)

(73) Assignee: TOYO ELECTRIC MFG. CO., LTD., Tokyo (JP)

(21) Appl. No.: 18/555,979

(22) PCT Filed: Apr. 27, 2022
(86) PCT No.: PCT/JP2022/019068

§ 371 Date: Aug. 13, 2024

(30) Foreign Application Priority Data
Jun. 17, 2021 (JP) 2021-100634

(51) Int. Cl. G01L 5/13; G01M 17/007

(52) U.S. Cl. CPC G01L 5/13; G01M 17/007

(57) ABSTRACT

On a premise that a longitudinal direction of an automobile is defined as an x-axis direction and a width direction of the automobile is defined as a y-axis direction, a supporting mechanism S includes a tilting support 2 which is disposed below a load motor M and tiltably supports the load motor M in an axis line direction of a rotational axis M1 of the load motor M with respect to a top-down direction, a rotary support 3 which is disposed below the load motor M and rotatably supports the load motor M in an x-y plane, a mounting frame 4 connected to the load motor M through the tilting support 2, a movable table 1 which is positioned just below the mounting frame 4 and connected to the mounting frame 4 through the rotary support 3, and a sliding portion 5 which is disposed just below each of end portions in the x-axis direction of the movable table 1 and is capable of causing the movable table 1 to slide in both the x-axis direction and the y-axis direction.

### TECHNICAL FIELD

The invention relates to a chassis dynamometer apparatus in which a load motor connected to a drive wheel connector of an automobile is supported by a supporting mechanism.

### BACKGROUND ART

Conventionally, as such a chassis dynamometer apparatus of this kind, the applicant has proposed a chassis dynamometer apparatus in which, on a premise that a longitudinal direction of the automobile is defined as an x-axis direction and a width direction of the automobile is defined as a y-axis direction, a mount includes a mounting frame to which the load motor is fixed and a base provided lower than the mounting frame, and a first movable table which is slidable in one of the x-axis direction and the y-axis direction, a second movable table which is slidable in the other of the x-axis direction and the y-axis direction, and a spherical joint which is tiltable and rotatable in an arbitrary direction are connected in series and are interposed between the mounting frame and the base (Patent Document No. 1, for example).

Incidentally, when the load motor rotates at the time of driving tests of the automobile, a counter-torque in a direction opposite to a direction of a rotation of the load motor is generated, and a radial load associated with the counter-torque acts on the spherical joint. Since a direction of the radial load is the same as a direction of a movement of the spherical joint, it has been newly discovered that when the radial load becomes large to a certain extent, it has been newly discovered that a defect may occur in which an inner cylinder of the spherical joint gets over a collar, thereby ceasing to function as a spherical joint.

### REFERENCE

Patent document No. 1: WO 2019/215864 A1

### SUMMARY OF INVENTION

### Technical Problem

In the light of the above-mentioned problem, an object of the invention is to provide a chassis dynamometer apparatus which can certainly realize tilting and rotation of the load motor despite the counter-torque generated when the load motor rotates.

### Solution to Problem

In order to achieve the foregoing object, the invention presupposes a chassis dynamometer apparatus in which a load motor connected to a drive wheel connector of an automobile is supported by a supporting mechanism. In the chassis dynamometer apparatus, on a premise that a longitudinal direction of the automobile is defines as an x-axis direction and a width direction of the automobile is defined as a y-axis direction, a supporting mechanism includes a tilting support disposed under the load motor and supporting the load motor so as to be tiltable in an axial direction of a rotational axis of the load motor with respect to a top-down direction, a rotary support disposed under the load motor and supporting the load motor so as to be rotatable in an x-y plane, a mounting frame disposed under the load motor and connected to the load motor through the tilting support, a movable table disposed just below the mounting frame and connected to the mounting frame through the rotary support, and a sliding portion which is disposed just below both of end portions in the x-axis direction of the movable table and capable of causing the movable table to slide both in the x-axis direction and in the y-axis direction. In addition, in the chassis dynamometer apparatus, on a premise that an attitude of the load motor in which the axial line of the rotational axis of the load motor is parallel to the y-axis direction is defined as a neutral attitude of the load motor, the tilting support includes a tilting shaft projecting from each of leg portions suspended at both ends in the x-axis direction of the load motor and extending in the x-axis direction, a first bearing for rotatably supporting each of the tilting shafts, the first bearing being provided at the mounting frame, and a first return device for returning the tilted load motor to the neutral attitude. Further, in the chassis dynamometer apparatus, the rotary support includes a rotary shaft suspended at a central portion in both the x-axis direction and the y-axis direction of the mounting frame, and a second bearing suspended at a central portion in both the x-axis direction and the y-axis direction of the movable table.

According to the invention, neither the tilting support nor the rotary support in the supporting mechanism for supporting the load motor, to which a spherical joint is not adopted, is affected by a radial load associated with a counter-torque generated by rotation of the load motor. Accordingly, tilting and rotation of the load motor can be certainly realized.

In the invention, it is desirable that each of the return devices includes fixed units having a pair of first inclined pieces extending diagonally upward and toward one and the other of the x-axis direction in a state where the attitude of the load motor is the neutral, respectively, and fixed to one and the other in the x-axis direction of the mounting frame, respectively, movable units having a pair of second inclined pieces each facing each of the first inclined pieces of the fixed units, and an elastic member(s) interposed between each of the first inclined pieces and each of the second inclined pieces, the elastic member(s) being pressed between each of the first inclined pieces and each of the second inclined pieces, and an elastic force being generated in the elastic member(s) when each of the movable units tilts associated with tilting of the load motor, and the elastic member(s) causing the load motor to return to the neutral attitude when the elastic force is released. According to this, the load motor can be automatically returned to a neutral attitude and structures of the first return device can be simplified.

In the invention, it is desirable that the sliding portions include a second return device which causes the movable table which has been slid in the x-axis direction and the y-axis direction to return to the neutral attitude before being slid. According to this, even though the movable table has been slid in at least one of the x-axis direction and the y-axis direction after the load motor has been mounted, performance of the automobile has been tested, or the like, the movable table can be automatically returned to the neutral attitude before being slid. This eliminates the time and effort required to return the movable table to the neutral attitude after mounting the load motor, performing a performance test, or the like.

### BRIEF DESCRIPTION OF THE DRAWINGS

FIG. 1 is a partially notched front view of an embodiment of a chassis dynamometer apparatus of the invention.

FIG. 2 is a partially notched side view of the chassis dynamometer apparatus shown in FIG. 1.

FIG. 3 is a main perspective view showing a portion of a tilting support provided with the chassis dynamometer apparatus shown in FIG. 1 together with a leg portion of the load motor.

FIG. 4 is a partially notched perspective view showing a tilted state of a load motor in the chassis dynamometer apparatus shown in FIG. 2.

FIG. 5A is a partial side view showing a second returning device provided in one side in the x-axis direction of sliding portions of the chassis dynamometer apparatus shown in FIG. 1, and FIG. 5B is a main side view showing the second returning device shown in FIG. 5A when the load motor shown in FIG. 1 slides to one side in the x-axis direction.

### DESCRIPTION OF EMBODIMENTS

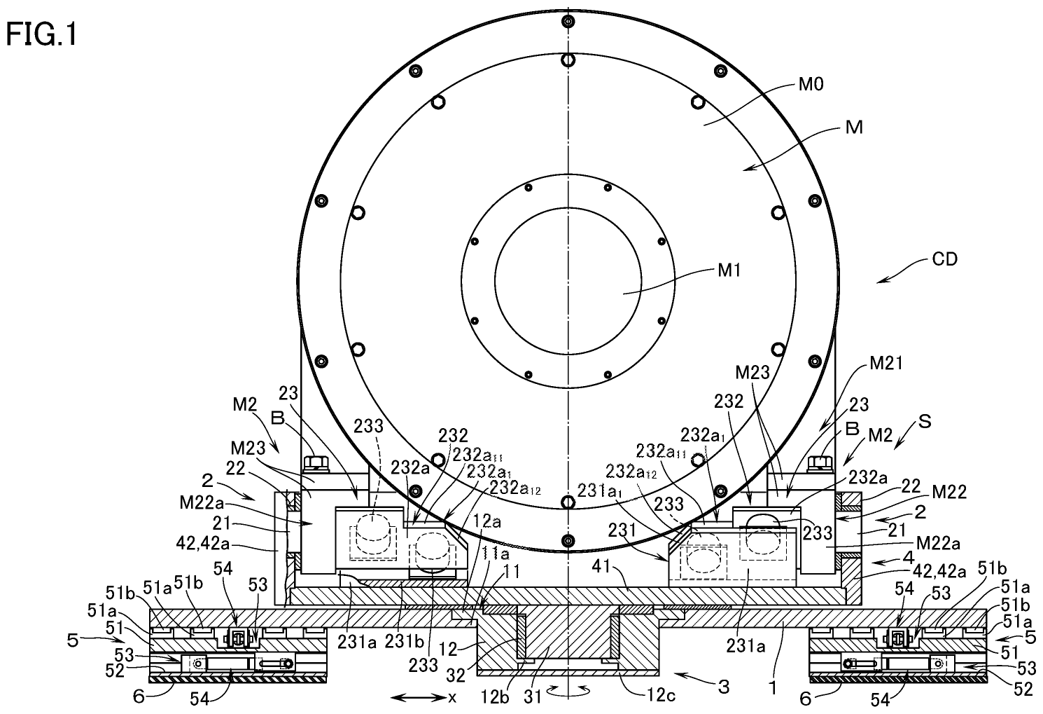

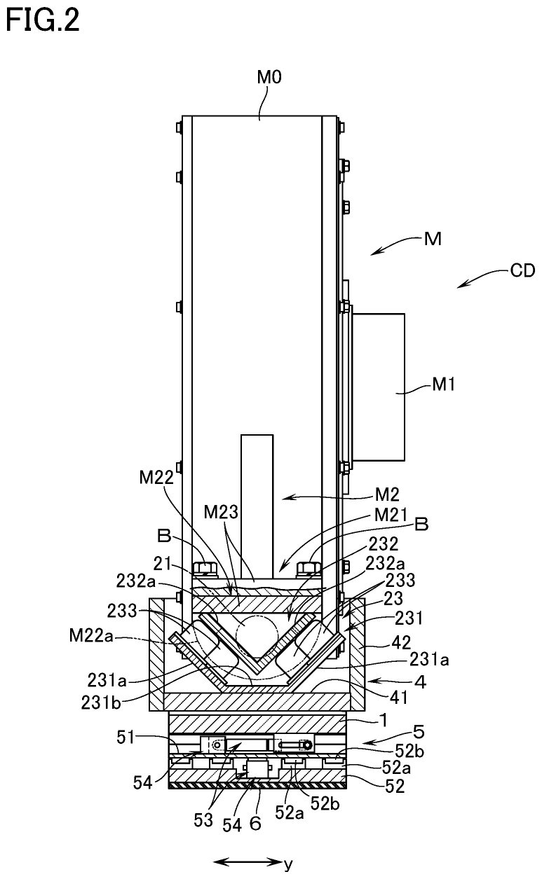

Referring to FIGS. 1 and 2, a chassis dynamometer will be described below. A load motor M is connected to a drive wheel connector, not shown, of an automobile in the chassis dynamometer apparatus CD. Thereafter, a longitudinal direction of the automobile is defined as an x-axis direction and a width direction of the automobile is defined as a y-axis direction.

An attitude of the chassis dynamometer apparatus CD shown in FIGS. 1 and 2 is defined as a neutral attitude in which an axial line of a rotational axis M1 of the load motor M is parallel to the y-axis direction, and a position of a movable table 1 which is slidable in both the x-axis direction and in the y-axis direction is neutral in which the movable table 1 is not slid in either of the x-axis direction or the y-axis direction.

The load motor M is supported by a supporting mechanism S in the chassis dynamometer apparatus CD so as to be tiltable in the axis line direction of the rotational axis M1 with respect to a top-down direction and to be rotatable in an x-y plane by a supporting mechanism S of the chassis dynamometer apparatus CD. The supporting mechanism S includes a tilting support 2 disposed under the load motor M, which supports the load motor M and supports the load motor M so as to be tiltable as above-mentioned, and a rotary support 3 which supports the load motor M so as to be rotatable in the x-y plane. In addition, the supporting mechanism S includes a mounting frame 4 disposed under the load motor M and connected to the load motor M through the tilting support 2, and the movable table 1 disposed just below the mounting frame 4 and connected to the mounting frame 4 through the rotary support 3. Further, the supporting mechanism S includes a sliding portion 5 disposed just below each of end portions in the x-axis direction of the movable table 1 and being capable of sliding as above-mentioned.

The tilting support 2 includes tilting shafts 21, 21 projecting in the x-axis direction from each of leg portions M2, M2 being suspended at both ends in the x-axis direction of the load motor M, and a first retuning device 23 for returning the load motor M tilted to a neutral attitude. A bottom wall 41 and an outer peripheral wall 42 standing over an outer periphery of the bottom wall 41 are provided with a mounting frame 4, and a first bearing 22 is incorporated in an inside of a portion 42a positioned at both ends in the x-axis direction of the outer peripheral wall 42. The tilting shaft 21 is fitted in the first bearing 22.

The rotary support 3 includes a rotary shaft 31 which is suspended at a central portion in both the x-axis direction and the y-axis direction of the bottom wall 41 of the mounting frame 4, and a second bearing 32 for rotatably supporting the rotary shaft 31, which is suspended at a central portion in both the x-axis direction and the y-axis direction of the movable table 1. A circular hole 11 having a step-down portion 11a which is one step lower is opened in the top-bottom direction at an upper half portion of the central portion in both the x-axis direction and the y-axis direction of the movable table 1. The flange portion 12a is stored in the step-down portion 11a of the circular hole 11 and fitted in a lower half portion of the circular hole 11, whereby a cylindrical casing 12 having a flange portion 12a projects below the circular hole 11. A projecting length of the casing 12 is set to be shorter than a height each of the sliding portions 5. An annular plate 12b projects an inner side in a radial direction at a lower end portion in an inside of the casing 12. A lower end of the second bearing 32 is placed on the annular plate 12b and the second bearing 32 is fitted in the casing 12. An upper end of the rotary shaft 31 is joined to a central portion at a lower end of the bottom wall 41 of the mounting frame 4 in both the x-axis direction and the y-axis direction, and is fitted in the second bearing 32. A lower end of the casing 12 is closed by a cover 12c.

Each of the first returning devices 23 includes a fixed unit 231 which has a pair of first inclined pieces 231a, 231a projecting diagonally upward to each of one side and the other side in the y-axis direction, and is fixed to each of one side and the other side in the x-axis direction of the bottom wall 41 of the mounting frame 4, and a movable unit 232 which has second inclined pieces 232a, 232a, each of which faces each of the first inclined pieces 231a, 231a of the fixed unit 231, is fixed to each of the leg portions M2, M2 of the load motor M, and tilts together with the load motor M. In addition, each of the returning device 23 includes elastic members 233, 233 interposed between each of the first inclined pieces 231a, 231a of the fixed unit 231 and each of the second inclined pieces 232a, 232a of the movable unit 232. When the movable units 232, 232 tilt associated with the load motor M, the elastic members 233, 233 are pressed between each of the first inclined pieces 231a, 231a and each of the second inclined pieces 232a, 232a, and an elastic force is generated in the elastic members 233, 233. Then, when the elastic force is released, the elastic members 233, 233 cause the load motor M to return to the neutral attitude. For example, a bushing made of rubber or the like can be applicable.

Specifically, the fixed unit 231 of each of the first returning devices 23 is joined to an upper surface of the bottom wall 41 of the mounting frame 4 through a rectangular flat plate 231b. The flat plate 231b is disposed between lower ends of each of the first inclined pieces 231a, 231a. The elastic members 233, 233 are fixed to an inner surface positioned on a side of the leg portion M2 of the load motor M at each of the first inclined pieces 231a, 231a, and project toward the second inclined piece 232a of each of the movable units 232, 232. Two of the elastic members 233, 233 are provided and aligned in parallel with a step-down in the x-axis direction. In the embodiment, at the each of the first inclined pieces 231a, 231a, in order to avoid contact with the load motor M at the time of rotating the load motor M, an upper portion which is positioned near one side of an axis line of the rotary shaft 31 of the rotary support 3 is notched diagonally downward to the bottom wall 41 of the mounting frame 4, and a notched portion 231a1 is formed.

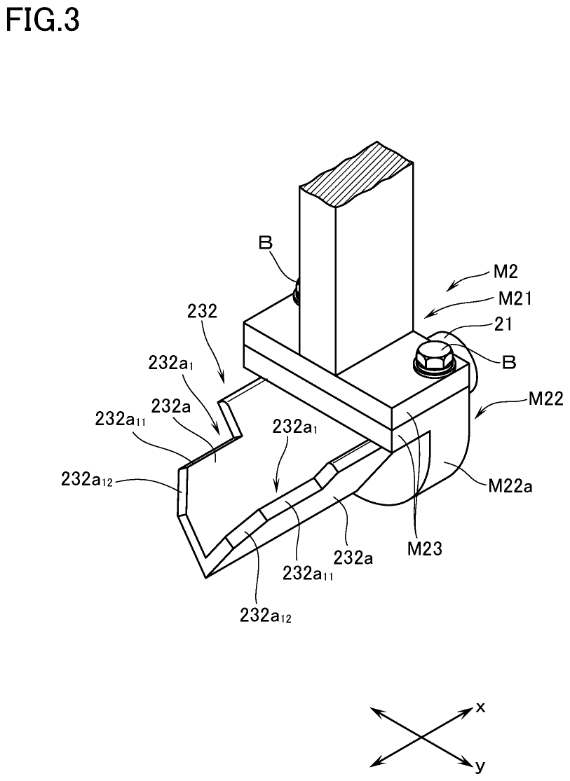

With reference also to FIG. 3, the movable unit 232 of each of the first returning devices 23, with which each of the second inclined pieces 232a, 232a is integrated, is V-shaped in a side view. A notched portion 232a₁ is formed at a portion, which is positioned near the axis line of the rotary shaft 31 of the rotary support 3, of an upper end portion of each of the second inclined pieces 232a, 232a of each of the movable units 232, 232 taking into account of a locus of the rotation in the x-y plane of the load motor M. The notched portion 232a₁ is positioned at a portion at which the notched portion 231a₁ is not formed, and consists of a stepped portion 232a₁₁ stepped down by one step from the portion at which the notched portion 232a₁ is not formed, and an inclined portion 232a₁₂ inclined diagonally downward from the stepped portion 232a₁₁ to the bottom wall 41 of the mounting frame 4. One of the two of the elastic members 233, 233 fixed to the second inclined pieces 232a, 232a of each of the fixed units 231, 231 is disposed opposite to a portion other than the notched portion 232a₁ of the second inclined pieces 232a, 232a of each of the movable units 232, 232, and the other is disposed opposite to the second inclined pieces 232a, 232a at the portion at which the notched portion 232a₁ is formed and which is lower than the elastic member 233 fixed to the portion other than the portion at which the notched portion 232a₁ is formed.

A lower end portion of each of the leg portions M2, M2 of the load motor M is divided into an upper portion M21 and a lower portion M22. Flange portions M23 having a rectangular shape extending in the y-axis direction and having the same size are provided at upper end portions of both a lower portion of the upper portion M21 and an upper end portion of the lower portion M22. The upper portion M21 and the lower portion M22 are fastened by a bolt B with overlapping each of the flange portions M23 at the top and the bottom. In addition, a main body M22a positioned just below the flange portion M23 of the lower portion M22 is disposed at both end sides in the x-axis direction of the bottom wall 41 of the mounting frame 4 and is formed into a semicircular plate member. The tilting shaft 21 of each of the tilting supports 2 is integrated with the main body M22a of each of the leg portions M2, M2, and projects toward the portion 42a positioned on both sides in the x-axis direction of the outer peripheral wall 42 of the mounting frame 4. Further, the movable unit 232 of each of the first returning devices 23 is joined to the main body M22a at a portion on a side of the main body M22a of the upper end portion of each of the second inclined pieces 232a, 232a at which the notched portion 232a1 is not formed, and is integrated with the main body M22a. Furthermore, a surface of each of the second inclined pieces 232a, 232a of the movable unit 232, which faces each of the first inclined pieces 231a, 231a of the fixed unit 231, does not press a projecting end of the elastic members 233, 233 but comes into contact with the elastic members 233, 233 in each of the first returning devices 23 when the load motor M is in the neutral attitude.

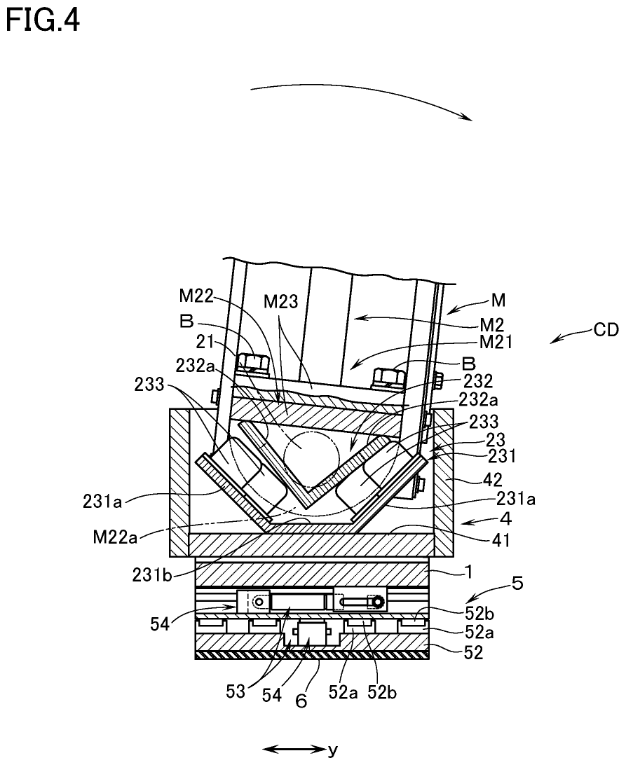

Referring to FIG. 4, when the load motor M is tilted clockwise at the time of attaching or detaching the load motor M to or from the drive wheel connectors of the automobile, performing a performance test of the automobile, or the like, the lower portion M22 of each of the leg portions M2, M2 of the load motor M is also tilted clockwise in connection with the tilting of the load motor M as the axis line of the tilting shaft 21 of each of the tilting supports 2, 2 is a center. Accordingly, each of the movable units 232, 232 integrated with the main body M22a of the lower portion M22 is tilted clockwise similarly to the load motor M. At this time, one of the second inclined pieces 232a, 232a of each of the movable units 232, 232 presses the two of the elastic members 233, 233 fixed to the one of the first inclined pieces 231a, 231a of each of the fixed units 231, 231 facing the one of the second inclined pieces 232a, 232a, and the elastic force is generated in both of the elastic members 233, 233. When the clockwise tilting of the load motor M is completed and the elastic force generated in both of the elastic members 233, 233 is released, the one of the second inclined pieces 232a, 232a of each of the movable units 232, 232 is pushed back counterclockwise, and the load motor M is returned to the neutral attitude associated with the pushing back. Such tilting out of and returning to the neutral attitude of the load motor M is also performed at the time of tilting of the load motor M counterclockwise.

In the chassis dynamometer apparatus CD of the embodiment, a spherical joint is not adopted to the supporting mechanism S of the load motor M, each of the tilting supports 2 tiltably supports the load motor M in the axis line direction of the rotational axis M1 of the load motor M with respect to the top-bottom direction, and the rotary support 3 provided in the supporting mechanism S rotatably supports the load motor M in the x-y plane. Namely, since the tilting shaft 21 provided in the tilting support 2 extends in the x-axis direction, and the rotary shaft 31 provided in the rotary support 3 extends in the top-bottom direction, each of the tilting support 2 and the rotary support 3 is not affected by a radial load associated with a counter-torque generated by the rotation of the load motor M. Accordingly, the tilting and the rotation of the load motor M can be certainly realized.

In addition, as above-mentioned, since each of the first returning devices 23 includes each of the fixed units 231, 231, each of the movable units 232, 232 and the elastic members 233, 233, the load motor M can be caused to return automatically and the structure of each of the first returning device 23 is simplified. Further, each of the first returning devices 23 does not interfere with the rotation of the load motor M.

Returning to FIGS. 1 and 2, each of the sliding portions 5 of the supporting mechanism S includes a first sliding table 51 and a second sliding table 52. Four of rails 51a extending longitudinally in the y-axis direction are fixed to an upper surface of the first sliding table 51 at a prescribed distance. One slider 51b slidable in a longitudinal direction of each of the rails 51a is provided on each of the rails 51a. The movable table 1 is mounted on a total of eight of the sliders 51b and freely slides in the y-axis direction. Four of rails 52a extending longitudinally in the x-axis direction are fixed to an upper surface of the second sliding table 52 at a prescribed distance. One slider 52b slidable in a longitudinal direction of each of the rails 52a is also provided on each of the rails 52a. The first sliding table 51 is mounted on total of eight of the sliders 52b and freely slides in the x-axis direction. Therefore, sliding in the x-axis direction of the slidable table 1 becomes possible. Thus, each of the sliding portions 5 can cause the movable table 1 to slide in both the x-axis direction and in the y-axis direction, the mounting frame 4 connected to the movable table 1 through the rotary support 3 can also slide in both the x-axis direction and in the y-axis direction, and as a result, the load motor M can slide in both the x-axis direction and the y-axis direction.

In this connection, the second sliding table 52 of the sliding portions 5 is left unmovable on a mounting table 6 fixed at a prescribed position on such as a floor surface of a test site when the performance test of the automobile is performed.

In addition, each of the sliding portions 5 includes a second returning device 54 for returning the movable table 1 slid in the x-axis direction and the y-axis direction at a notched portion 53 formed by downwardly notching a central portion of each of upper surfaces of the first sliding tables 51 and the second sliding tables 52.

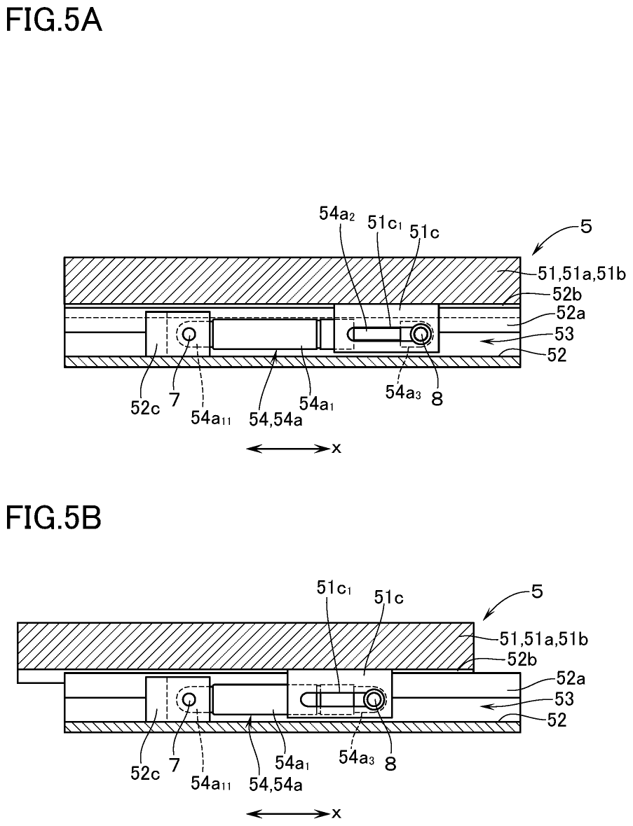

Referring to FIGS. 5A and 5B, the second returning device 54 will be described below. The second returning device 54 shown in FIGS. 5A and 5B is arranged in the sliding portion 5 positioned at one end in the x-axis direction, i.e., a left end in FIG. 1, of the movable table 1 shown in FIG. 1. The second returning device 54 in the sliding portion 5 positioned at the other end in the x-axis direction, i.e., a right end of the movable table 1 is symmetrically arranged with the axis line of the rotary shaft 31 of the rotary support 3 as an axis of symmetry with respect to the second returning device 54 shown in FIGS. 5A and 5B.

A first fixed plate 51c projects downward from a portion positioned on a side in the vicinity of the rotary support 3 shown in FIG. 1 on a lower surface of the first sliding table 51. A lower end of the first fixed plate 51c does not come into contact with a lower end surface of the notched portion 53. In addition, a long hole 51c₁ extending in the x-axis direction is opened in the y-axis direction. On the other hand, a second fixed plate 52c projects upwardly from a portion of an upper surface of the second sliding table 52, which is positioned on a side further from the rotary support 3. An upper end of the second fixed plate 52c does not come into contact with a lower surface of the first sliding table 51. An air damper 54a is adopted to the second returning device 54. The air damper 54a includes a cylinder 54a₁ longitudinally in the x-axis direction, a piston rod 54a₂ which enters and exits the cylinder 54a₁, and a head 54a₃ provided at a tip end portion positioned opposite to the cylinder 54a₁ of the piston rod 54a₂. One end portion 54a₁₁ positioned opposite to the head 54a₃ of the cylinder 54a₁ is fixed to the second fixed plate 52c by a first pin 7. In addition, a second pin 8 which is movable in the long hole 51c₁ in the longitudinal direction thereof of the first fixed plate 51c and inserted in the y-axis direction is provided with the head 54a₃.

When the movable table 1 shown in FIG. 1 slides to one side in the x-axis direction, i.e., to the left side in FIG. 1, as shown in FIG. 5B, the first sliding table 51 of the supporting portion 5 slides in the same direction associated with the movable table 1. At this time, while the second pin 8 comes into contact with the other end in the x-axis direction, i.e., the right end in FIG. 5, the head 54a₃ moves to the one side in the x-axis direction, the piston rod 54a₂ enters the cylinder 54a₁, and an internal pressure of the cylinder 54a₁ becomes high. A sliding limit to the one side in the x-axis direction of the movable table 1 is up to contact of the head 54a₃ with the cylinder 54a₁. When the performance test of the automobile or the like is completed and the sliding of the movable table 1 is stopped, the head 54a₃ is pushed back to the other side in the x-axis direction by the internal pressure of the cylinder 54a₁, and the movable table 1 returns to the neutral position shown in FIG. 5A.

When the movable table 1 slides to the other side, i.e., the right side in FIG. 1, the air damper 54a as the second returning device 54 in the sliding portion 5 shown in FIG. 1 and positioned on the other side in the x-axis direction is activated as above-mentioned and causes the movable table 1 to return to the neutral position at the stop of the sliding. On the other hand, in the sliding portion 5 shown in FIGS. 5A and 5B, the second pin 8 moves only in the long hole 51c₁ from the other end to the other end in the x-axis direction, i.e., from the right end to the left end shown in FIGS. 5A and 5B, and the piston rod 54a₂ does not enter the cylinder 54a₁. Accordingly, the internal pressure of the cylinder 54a₁ in the air damper 54a as the second returning device 54 shown in FIGS. 5A and 5B is not changed. Thus, when the movable table 1 slides to one side and the other side in the x-axis direction, the movable table 1 is returned to the neutral position by the air damper 54a as the second returning device 54, which is provided with one of the sliding portions 5.

In the slidable table 1, as shown in FIG. 1, a like the first fixed plate 51c is protruded at a portion corresponding to the notched portion 53 formed on the first sliding table 51, and a like the second fixed plate 52c is protruded in the first sliding table 51. The air damper 54a as the second retuning device 54 is also provided at the notched portion 53 of the first sliding table 51. Accordingly, the sliding in the y-axis direction and returning to the neutral position of the movable table 1 is performed as above-mentioned.

Since the second returning device 54 as above-mentioned is provided with each of the sliding portions 5, even though the movable table 1 has been slid in at least one of the x-axis direction and the y-axis direction after the installation of the load motor M, the performance test of the automobile, or the like, the movable table 1 can be automatically returned to the neutral position before the sliding. Therefore, this eliminates the time and effort required to return the movable table 1 to the neutral attitude after mounting the load motor M, performing a performance test, or the like.

Although the invention is descried regarding the above-mentioned embodiment, the invention is not limited to the above-mentioned embodiment. For example, a shape of the first inclined piece 231a of each of the fixed units 231, 231 and the second inclined piece 232a of the each of the movable units 232, 232, and a composition, a structure, and a number of the elastic members 233 are not particularly limited. In addition, a suitable one selected from a plurality of members in which the elastic force is generated, such as a spring other than the air damper 54a, can be adopted for the second returning device 54.

### EXPLANATION OF SYMBOLS

CD Chassis dynamo apparatus
M Load motor
M1 Rotational axis
M2 Leg portion
S Supporting mechanism
1 Movable table
2 Tilting support
21 Tilting shaft
22 First bearing
23 First returning device
231 Fixed unit
231a First inclined piece
232 Movable unit
232a Second inclined piece
233 Elastic member
3 Rotary support
31 Rotary shaft
32 Second bearing
4 Mounting frame
5 Sliding portion
54 Second returning device

1. A chassis dynamometer apparatus in which a load motor connected to a drive wheel connector of an automobile is supported by a supporting mechanism,
on a premise that a longitudinal direction of the automobile is defined as an x-axis direction and a width direction of the automobile is defined as a y-axis direction, a supporting mechanism comprises a tilting support disposed under the load motor and supporting the load motor so as to be tiltable in an axial direction of a rotational axis of the load motor with respect to a top-down direction; a rotary support disposed under the load motor and supporting the load motor so as to be rotatable in an x-y plane; a mounting frame disposed under the load motor and connected to the load motor through the tilting support; a movable table disposed just below the mounting frame and connected to the mounting frame through the rotary support; and a sliding portion which is disposed just below both of end portions in the x-axis direction of the movable table and capable of causing the movable table to slide both in the x-axis direction and in the y-axis direction,
wherein on a premise that an attitude of the load motor in which the axial line of the rotational axis of the load motor is parallel to the y-axis direction is defined as a neutral attitude of the load motor, the tilting support comprises a tilting shaft projecting from each of leg portions suspended at both ends in the x-axis direction of the load motor and extending in the x-axis direction; a first bearing for rotatably supporting each of the tilting shafts, the first bearing being provided at the mounting frame; and a first return device for returning the tilted load motor to the neutral attitude, and
wherein the rotary support comprises a rotary shaft suspended at a central portion in both the x-axis direction and the y-axis direction of the mounting frame; and a second bearing suspended at a central portion in both the x-axis direction and the y-axis direction of the movable table.

2. The chassis dynamometer apparatus as claimed in claim 1, wherein each of the return devices comprises fixed units having a pair of first inclined pieces extending diagonally upward and toward one and the other of the x-axis direction in a state where the attitude of the load motor is the neutral, respectively, and fixed to one and the other in the x-axis direction of the mounting frame, respectively; movable units having a pair of second inclined pieces each facing each of the first inclined pieces of the fixed units; and an elastic member(s) interposed between each of the first inclined pieces and each of the second inclined pieces, the elastic member(s) being pressed between each of the first inclined pieces and each of the second inclined pieces, and an elastic force being generated in the elastic member(s) when each of the movable units tilts associated with tilting of the load motor, and the elastic member(s) causing the load motor to return to the neutral attitude when the elastic force is released.

3. The chassis dynamometer apparatus as claimed in claim 1, wherein the sliding portions comprise a second return device which causes the movable table which has been slid in the x-axis direction and the y-axis direction to return to the neutral attitude before being slid.
